(19) United States
(12) Patent Application Publication
(10) Pub. No.: US 2007/0289836 A1
(43) Pub. Date: Dec. 20, 2007

(54) Bicycle hub having pawl retaining function

(76) Inventors: Yi-De Lin, Fongshan City (TW); Shu-Tzu Tsai Tu, Ta Ya Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/455,051

(22) Filed: Jun. 16, 2006

(51) Int. Cl. F16D 41/30

(52) U.S. Cl. 192/64

(57) ABSTRACT

A hub for a bicycle includes a hub body having ratchet teeth, a ratchet barrel having positioning grooves, a plurality of pawl members pivotally mounted in the positioning grooves of the ratchet barrel and engaged with the ratchet teeth of the hub body in one direction, and an elastic module enclosed around the pawl members elastically. The elastic module is formed by a plurality of loops connected with each other. Thus, the force applied by the pawl members on the elastic module are distributed by the loops of the elastic module in the axial and sideward directions, so that the elastic module has a greater strength and will not produce an elastic fatigue during a long-term utilization, thereby enhancing the lifetime of the elastic module.

### BACKGROUND OF THE INVENTION

1. Field of the Invention

The present invention relates to a hub and, more particularly, to a hub for a bicycle.

2. Description of the Related Art

A conventional hub for a bicycle in accordance with the prior art shown in FIGS. 6-8 comprises a shaft (not shown), a hub body (not shown) rotatably mounted on the shaft and having a side having an inner wall formed with a ratchet face (not shown) having a plurality of ratchet teeth (not shown), a ratchet barrel 20 having a side mounted on the ratchet face of the hub body and having an outer wall formed with a plurality of positioning grooves 22, a plurality of pawl members 21 pivotally mounted in the positioning grooves 22 of the ratchet barrel 20 respectively and engaged with the ratchet teeth of the hub body in one direction respectively, and a metallic ring 10 enclosed around and pressing the pawl members 21 to pivot the pawl members 21 outwardly so that the pawl members 21 are engaged with the ratchet teeth of the hub body in one direction. Each of the pawl members 21 has an outer face formed with a retaining groove 211 to retain the metallic ring 10. Thus, when the ratchet barrel 20 is driven by a chain wheel (not shown), the pawl members 21 are engaged with the ratchet teeth of the hub body in one direction respectively, so that the hub body is driven by the ratchet barrel 20 to rotate in one direction.

When in use, some of the pawl members 21 are pressed and pivoted outwardly to engage with the ratchet teeth of the hub body so that the metallic ring 10 is expanded, and other ones of the pawl members 21 are pressed by the ratchet face of the hub body so that the metallic ring 10 is loosened. Thus, the metallic ring 10 is expanded and loosened successively by actions of the pawl members 21.

However, the metallic ring 10 is expanded and loosened successively, so that the metallic ring 10 will produce an elastic fatigue during a long-term utilization, thereby decreasing the lifetime of the metallic ring 10. In addition, the pawl members 21 are not engaged with the ratchet teeth of the hub body closely and exactly when the metallic ring 10 produces an elastic fatigue.

### BRIEF SUMMARY OF THE INVENTION

In accordance with the present invention, there is provided a hub, comprising a hub body having a side having an inner wall formed with a ratchet face having a plurality of ratchet teeth, a ratchet barrel having a side mounted on the ratchet face of the hub body and having an outer wall formed with a plurality of positioning grooves, a plurality of pawl members pivotally mounted in the positioning grooves of the ratchet barrel respectively and engaged with the ratchet teeth of the hub body in one direction respectively, and an elastic module enclosed around and pressing the pawl members elastically to pivot the pawl members outwardly so that the pawl members are engaged with the ratchet teeth of the hub body in one direction.

The primary objective of the present invention is to provide a bicycle hub having a pawl retaining function.

Another objective of the present invention is to provide a hub, wherein each of the pawl members is pressed by the axially tensile elastic force and the sideward bending elastic force of the loops of the elastic module, so that the pawl members are engaged with the ratchet teeth of the hub body rigidly and stably by the pressing force of the elastic module.

A further objective of the present invention is to provide a hub, wherein the force applied by the pawl members on the elastic module are distributed by the loops of the elastic module in the axial and sideward directions, so that the elastic module has a greater strength and will not produce an elastic fatigue during a long-term utilization, thereby enhancing the lifetime of the elastic module.

A further objective of the present invention is to provide a hub, wherein the elastic module has a greater strength, so that the pawl members are engaged with the ratchet teeth of the hub body closely and exactly by the pressing force of the elastic module.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a hub in accordance with the preferred embodiment of the present invention.

FIG. 2 is a partially perspective assembly view of the hub as shown in FIG. 1.

FIG. 3 is a plan cross-sectional view of the hub as shown in FIG. 2.

FIG. 4 is a schematic operational view of the hub as shown in FIG. 3.

FIG. 5 is a locally enlarged view of the hub as shown in FIG. 4.

FIG. 6 is a plan cross-sectional assembly view of a conventional hub in accordance with the prior art.

FIG. 7 is a schematic operational view of the conventional hub as shown in FIG. 6.

FIG. 8 is a locally enlarged view of the conventional hub as shown in FIG. 6.

### DETAILED DESCRIPTION OF THE INVENTION

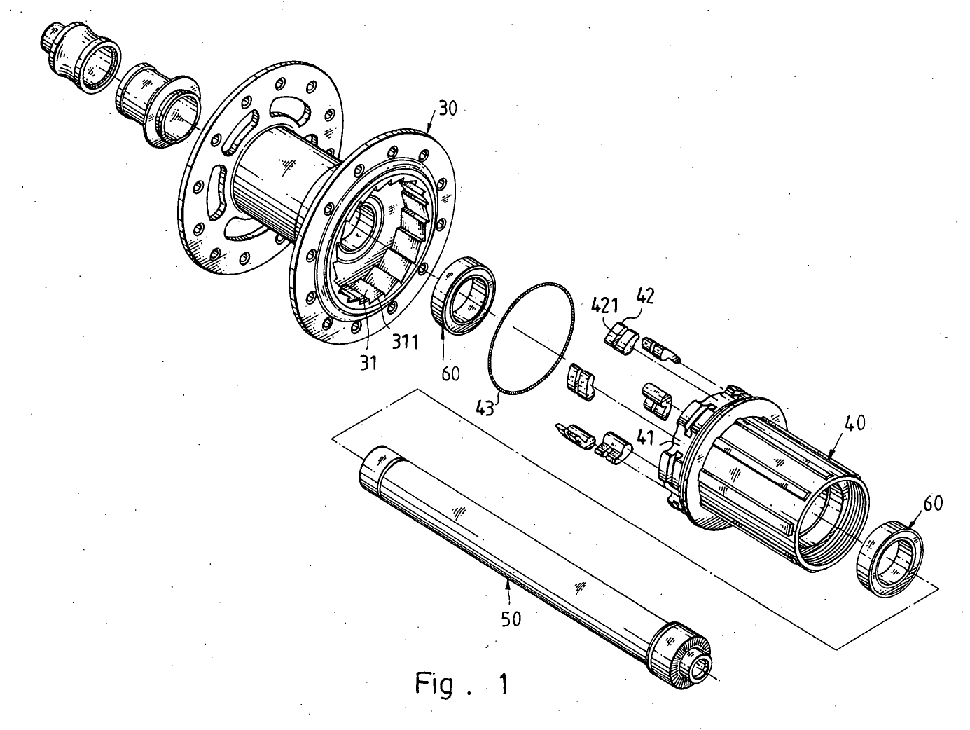

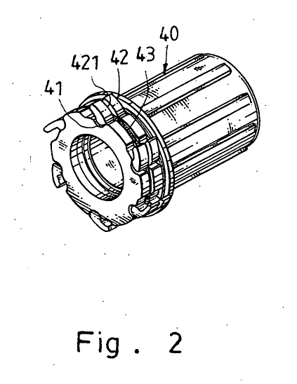

Referring to the drawings and initially to FIGS. 1-3, a hub for a bicycle in accordance with the preferred embodiment of the present invention comprises a shaft 50, a hub body 30 rotatably mounted on the shaft 50 and having a side having an inner wall formed with a ratchet face 31 having a plurality of ratchet teeth 311, a ratchet barrel 40 having a side mounted on the ratchet face 31 of the hub body 30 and having an outer wall formed with a plurality of positioning grooves 41, a plurality of bearings 60 mounted between the shaft 50, the hub body 30 and the ratchet barrel 40, a plurality of pawl members 42 pivotally mounted in the positioning grooves 41 of the ratchet barrel 40 respectively and engaged with the ratchet teeth 311 of the hub body 30 in one direction respectively, and an elastic module 43 enclosed around and pressing the pawl members 42 elastically to pivot the pawl members 42 outwardly so that the pawl members 42 are engaged with the ratchet teeth 311 of the hub body 30 in one direction. Each of the pawl members 42 has an outer face formed with a retaining groove 421 to retain the elastic module 43.

Referring to FIGS. 1-5, the elastic module 43 is an annular spring strip and formed by a plurality of loops 431 connected with each other. The loops 431 of the elastic module 43 are wound and extended successively. Each of the loops 431 of the elastic module 43 has a helical shape. Each of the loops 431 of the elastic module 43 has an axially tensile elastic force and has a sideward bending elastic force.

In assembly, some of the pawl members 42 are initially mounted in the positioning grooves 41 of the ratchet barrel 40. Then, the elastic module 43 are enclosed around the respective pawl members 42 and retained by the retaining grooves 421 of the respective pawl members 42. Then, other ones of the pawl members 42 are inserted between the positioning grooves 41 of the ratchet barrel 40 and the elastic module 43, so that all of the pawl members 42 are mounted between the ratchet barrel 40 and the elastic module 43. At this time, the bottom face of the retaining groove 421 of each of the pawl members 42 is pressed downward elastically by the axially tensile elastic force and the sideward bending elastic force of the loops 431 of the elastic module 43, so that the pawl members 42 are pivoted outwardly as shown in FIG. 3 and are engaged with the ratchet teeth 311 of the hub body 30 in one direction.

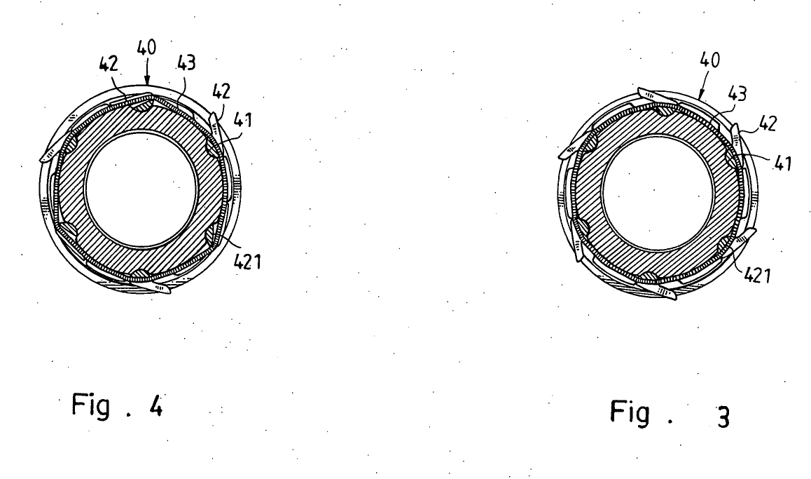

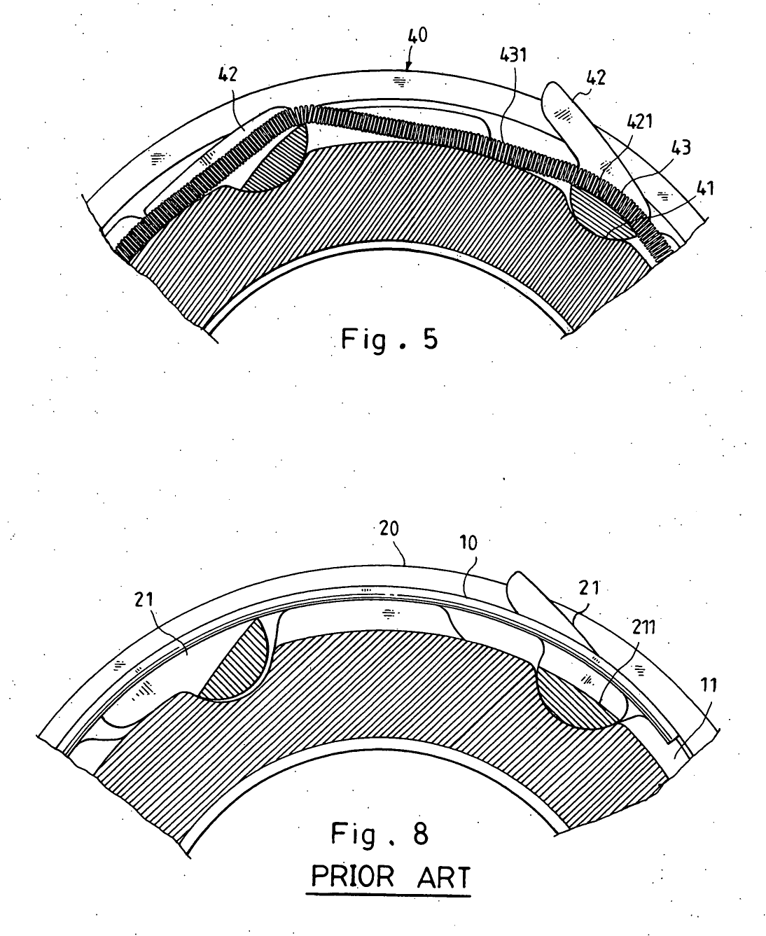

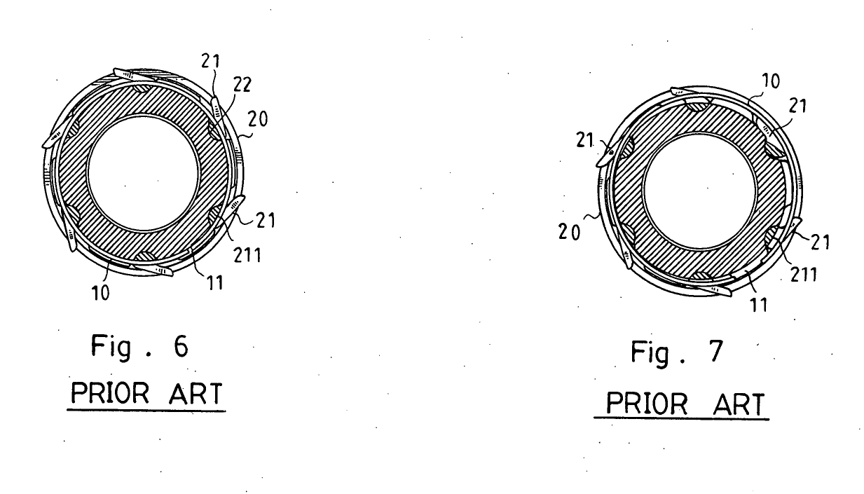

As shown in FIGS. 4 and 5, after the ratchet barrel 40 is mounted onto the hub body 30, some of the pawl members 42 are pressed and pivoted outwardly to engage with the ratchet teeth 311 of the hub body 30 so that the elastic module 43 is expanded, and other ones of the pawl members 42 are pressed downward elastically by the ratchet face 31 of the hub body 30 so that the elastic module 43 is loosened. At this time, each of the pawl members 42 is pressed by the axially tensile elastic force and the sideward bending elastic force of the loops 431 of the elastic module 43, so that the pawl members 42 are engaged with the ratchet teeth 311 of the hub body 30 rigidly and stably by the pressing force of the elastic module 43. In addition, the force applied by the pawl members 42 on the elastic module 43 are distributed by the loops 431 of the elastic module 43 in the axial and sideward directions, so that the elastic module 43 has a greater strength and will not produce an elastic fatigue during a long-term utilization, thereby enhancing the lifetime of the elastic module 43. Further, the elastic module 43 has a greater strength, so that the pawl members 42 are engaged with the ratchet teeth 311 of the hub body 30 closely and exactly by the pressing force of the elastic module 43.

Accordingly, each of the pawl members 42 is pressed by the axially tensile elastic force and the sideward bending elastic force of the loops 431 of the elastic module 43, so that the pawl members 42 are engaged with the ratchet teeth 311 of the hub body 30 rigidly and stably by the pressing force of the elastic module 43. In addition, the force applied by the pawl members 42 on the elastic module 43 are distributed by the loops 431 of the elastic module 43 in the axial and sideward directions, so that the elastic module 43 has a greater strength and will not produce an elastic fatigue during a long-term utilization, thereby enhancing the lifetime of the elastic module 43. Further, the elastic module 43 has a greater strength, so that the pawl members 42 are engaged with the ratchet teeth 311 of the hub body 30 closely and exactly by the pressing force of the elastic module 43.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hub, comprising:
a hub body having a side having an inner wall formed with a ratchet face having a plurality of ratchet teeth;
a ratchet barrel having a side mounted on the ratchet face of the hub body and having an outer wall formed with a plurality of positioning grooves;
a plurality of pawl members pivotally mounted in the positioning grooves of the ratchet barrel respectively and engaged with the ratchet teeth of the hub body in one direction respectively;
an elastic module enclosed around and pressing the pawl members elastically to pivot the pawl members outwardly so that the pawl members are engaged with the ratchet teeth of the hub body in one direction.

2. The hub in accordance with claim 1, wherein the elastic module is formed by a plurality of loops connected with each other.

3. The hub in accordance with claim 2, wherein the loops of the elastic module are wound and extended successively.

4. The hub in accordance with claim 2, wherein each of the loops of the elastic module has a helical shape.

5. The hub in accordance with claim 1, wherein each of the loops of the elastic module has an axially tensile elastic force and has a sideward bending elastic force.

6. The hub in accordance with claim 1, wherein the elastic module is an annular spring strip.

7. The hub in accordance with claim 5, wherein each of the pawl members has an outer face formed with a retaining groove to retain the elastic module.

8. The hub in accordance with claim 7, wherein the retaining groove of each of the pawl members has a bottom face pressed downward elastically by the axially tensile elastic force and the sideward bending elastic force of the loops of the elastic module, so that the pawl members are pivoted outwardly and are engaged with the ratchet teeth of the hub body by the pressing force of the elastic module.

9. The hub in accordance with claim 5, wherein a force applied by the pawl members on the elastic module are distributed by the loops of the elastic module in the axial and sideward directions.
